(19) United States
(12) Patent Application Publication
(10) Pub. No.: US 2025/0301081 A1
(43) Pub. Date: Sep. 25, 2025

(54) INFORMATION PROCESSING SYSTEM, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventor: Hidefumi NISHIGAI, Kanagawa (JP)

(73) Assignee: FUJIFILM Business Innovation Corp., Tokyo (JP)

(21) Appl. No.: 18/770,601

(22) Filed: Jul. 11, 2024

(30) Foreign Application Priority Data
Mar. 22, 2024 (JP) 2024-047164

(51) Int. Cl. H04N 1/00; G06K 15/00

(52) U.S. Cl. CPC H04N 1/00856; G06K 15/407; G06K 15/4095

(57) ABSTRACT

An information processing system includes at least one processor configured to: print hidden information by using a predetermined first coloring material in a case of executing printing of image information on a recording medium using plural coloring materials; and not print the hidden information in a case in which the first coloring material is replaced with a second coloring material.

### CROSS-REFERENCE TO RELATED APPLICATIONS

This application is based on and claims priority under 35 USC 119 from Japanese Patent Application No. 2024-047164 filed Mar. 22, 2024.

### BACKGROUND

### (i) Technical Field

The present invention relates to an information processing system, a non-transitory computer readable medium storing an information processing program, and an information processing method.

### (ii) Related Art

JP1996-84251A describes an image processing apparatus that, in a case of adding a tracking pattern that is difficult to identify or is unidentifiable by the naked eye to a copy, prevents the tracking pattern on the copy from being visible even in a case of copying a document to which the tracking pattern has already been added.

### SUMMARY

Aspects of non-limiting embodiments of the present disclosure relate to an information processing system, a non-transitory computer readable medium storing an information processing program, and an information processing method that can prevent hidden information from being printed by a second coloring material in a case in which a first coloring material that is determined in advance as a coloring material for printing the hidden information is replaced with the second coloring material.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including: at least one processor configured to: print hidden information by using a predetermined first coloring material in a case of executing printing of image information on a recording medium using a plurality of coloring materials; and not print the hidden information in a case in which the first coloring material is replaced with a second coloring material.

### BRIEF DESCRIPTION OF THE DRAWINGS

Exemplary embodiment(s) of the present invention will be described in detail based on the following figures, wherein:

FIG. 1 is a block diagram showing an example of an electrical configuration of an information processing system according to an exemplary embodiment;

FIG. 2 is a block diagram showing an example of a functional configuration of the information processing system according to the exemplary embodiment;

FIG. 3 is a flowchart showing an example of hidden information printing determination processing in the information processing system according to the exemplary embodiment; and

FIG. 4 is a flowchart showing another example of the hidden information printing determination processing in the information processing system according to the exemplary embodiment.

### DETAILED DESCRIPTION

Hereinafter, an information processing system, an information processing program, and an information processing method according to an exemplary embodiment of the present disclosure will be described with reference to the accompanying drawings. Components indicated by the identical reference numeral in the respective drawings mean the identical components. However, unless otherwise noted in the specification, the number of each component is not limited to one, and a plurality of each component may be present.

Further, the description of duplicate configurations and reference numerals in the respective drawings may be omitted. The present disclosure is not limited to the following exemplary embodiments, and can be implemented with appropriate modifications such as omission of configurations, replacement with different configurations, and use in combination with one exemplary embodiment and various modification examples, without departing from the scope of the present disclosure.

### Information Processing System

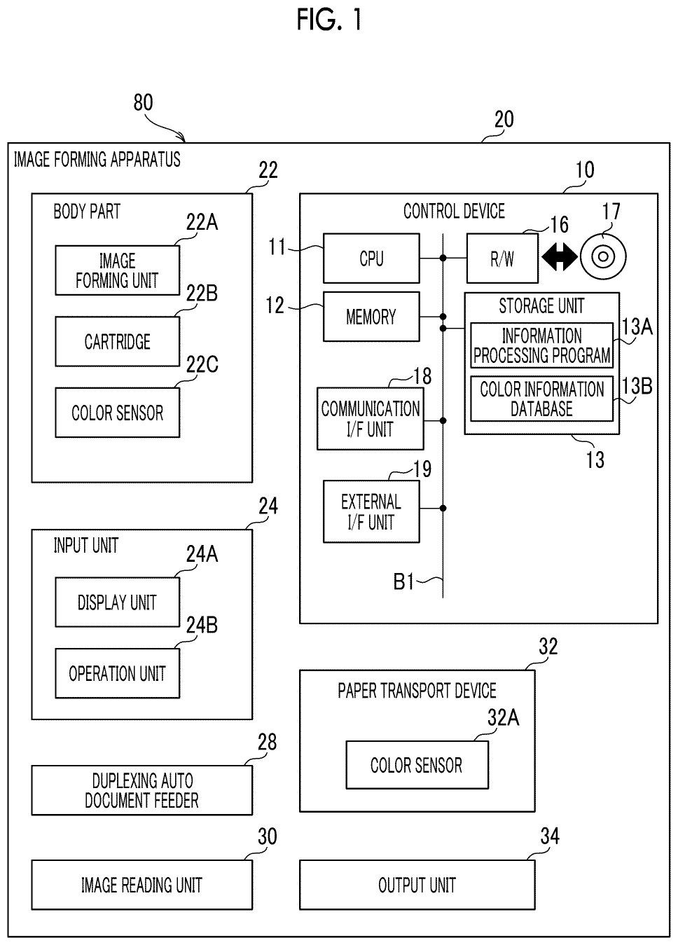

An information processing system 80 shown in FIG. 1 is a system built in an image forming apparatus 20. The term “system” in the exemplary embodiment of the present disclosure includes a system configured by a single apparatus, a system configured by a plurality of apparatuses, and a system constructed in a higher-level apparatus or system. That is, the information processing system 80 according to the exemplary embodiment of the present disclosure may be configured over a plurality of apparatuses other than the image forming apparatus 20.

Various types of processing executed by the information processing system 80 can also be executed in a cloud, an on-premises server, an edge server, an endpoint, and the like.

Details will be described below, but the information processing system 80 can prevent hidden information from being printed by a coloring material other than a predetermined coloring material in the image forming apparatus 20 that can print the hidden information.

Image Forming Apparatus

The image forming apparatus 20 according to the present exemplary embodiment receives a job via an input operation performed by a user and executes a designated job. An example of the job executed by the image forming apparatus 20 is a printing job of forming a document image generated from a loaded document or the like on a recording medium such as paper.

The document loaded into the image forming apparatus 20 may be a document set in an image reading unit 30, which will be described below, or a document acquired from a network via a communication interface (I/F) unit 18, which will be described below.

The image forming apparatus 20 is formed of a body part 22, an input unit 24, a duplexing auto document feeder 28, the image reading unit 30, a paper transport device 32, and an output unit 34. In addition, the image forming apparatus 20 includes a control device 10.

The image forming apparatus 20 can print “hidden information” as a tracking pattern that is difficult to identify with the naked eye on the recording medium. The hidden information is printed by dots having a size equal to or smaller than a predetermined size. The hidden information is printed by using a coloring material of a color that is not conspicuous.

### Body Part

The body part 22 is a housing in which an image forming unit 22A, a cartridge 22B, a color sensor 22C, and the like are stored.

The image forming unit 22A forms the document image generated by the image reading unit 30 described below on the recording medium such as paper, for example, by using an electrophotographic method, an ink jet recording method, or the like.

In a case in which the image forming unit 22A adopts the electrophotographic method, the cartridge 22B is a toner cartridge containing a toner as an example of the coloring material. Further, in a case in which the image forming unit 22A adopts the ink jet recording method, the cartridge 22B is an ink cartridge containing an ink as an example of the coloring material.

The image forming apparatus 20 can print image information on the recording medium by using a plurality of coloring materials. Therefore, a plurality of cartridges 22B are stored in the image forming apparatus 20. These cartridges 22B can be stored in a combination of various coloring materials.

Examples of the combination of the coloring materials include the following combinations.
Black, cyan, magenta, and yellow
Black, silver, gold, and white
Black, silver, gold, and transparent
Silver, cyan, magenta, and yellow

Among these, the yellow and transparent coloring materials are a “first coloring material” that can print the “hidden information”, and the other colors are a “second coloring material” that does not print the hidden information in general. The hidden information may be printed by using the second coloring material, but the details will be described below.

The color sensor 22C is a color identification sensor capable of identifying the color of the coloring material filled in the cartridge 22B. The color sensor 22C can identify the color of the coloring material filled in each cartridge 22B. In addition, the color sensor 22C can identify whether or not the first coloring material is included in the coloring material filled in each cartridge 22B.

### Input Unit

The input unit 24 is an interface that allows the user to perform the input operation of the job executed by the image forming apparatus 20. The user can input an execution instruction for printing of the image information and an execution instruction for printing of the hidden information via the input unit 24. The input unit 24 includes a display unit 24A and an operation unit 24B. The hidden information may be printed regardless of the execution instruction of the user.

The display unit 24A is configured by combining, for example, a touch panel with a liquid crystal display, an organic EL display, or the like. An image or the like is displayed on the display unit 24A, in response to a touch operation of the user, processing of the image forming apparatus 20, or the like. The operation unit 24B is an operation key, an operation button, a power button, and the like that are provided in the image forming apparatus 20.

The user can designate a job content to the image forming apparatus 20 or input an execution instruction for the job by performing the touch operation on the display unit 24A, pressing the operation button on the operation unit 24B, or the like. The input operation of the user may be performed via the operation unit 24B.

### Duplexing Auto Document Feeder

The duplexing auto document feeder 28 (DADF) is a transport device that transports the document by a transport roller (not shown). The duplexing auto document feeder 28 is installed at an upper end portion of the body part 22, and serves as a platen cover that covers the image reading unit (platen glass) 30, which will be described below, and is disposed to be openable and closable.

The duplexing auto document feeder 28 is provided with a paper table. The paper table is a tray on which one or a plurality of documents to be read by the image reading unit 30 can be set.

### Image Reading Unit

The image reading unit 30 is a platen including a charge-coupled device (CCD) image sensor or the like that reads the document set on the paper table of the duplexing auto document feeder 28 to generate the document image on an upper end surface of the body part 22.

By opening the duplexing auto document feeder 28 as the platen cover, one document to be read by the image reading unit 30 can be set in the image reading unit 30.

### Paper Transport Device

The paper transport device 32 transports the paper as the recording medium supplied from a paper tray provided on a lower end portion side of the body part 22 on a paper transport path. The paper tray can be set with the paper for forming the document image by the image forming unit 22A.

A paper tray for manual feeding is also provided on a side surface of the body part 22 in the image forming apparatus 20, and the paper for forming the document image by the image forming unit 22A can also be set in the paper tray.

A color sensor 32A is provided on the paper transport path in the paper transport device 32. The color sensor 32A is a color identification sensor capable of identifying the color of the paper transported on the paper transport path.

### Output Unit

The output unit 34 includes a paper discharge tray provided on a side surface of the body part 22. An output product in which the document image is formed in the image forming unit 22A is output to the paper discharge tray. In the output unit 34, only one paper discharge tray or a plurality of paper discharge trays may be provided.

### Control Device

The control device 10 receives a job via the input operation performed by the user on the image forming apparatus 20, and executes control of causing the image forming apparatus 20 to execute the designated job. The control device 10 determines whether or not to print the hidden information on the recording medium.

### Electrical Configuration of Control Device

The control device 10 includes a CPU 11, a memory 12 as a temporary storage region, a non-volatile storage unit 13, a medium reading/writing device (R/W) 16, a communication interface (I/F) unit 18, and an external I/F unit 19. The CPU 11, the memory 12, the storage unit 13, the medium reading/writing device 16, the communication I/F unit 18, and the external I/F unit 19 are connected to each other via a bus B1. The medium reading/writing device 16 reads out information written on a recording medium 17 and writes information on the recording medium 17. The communication I/F unit 18 is, for example, an interface for communicably connecting a server provided outside the control device 10 and various terminals used by the user to the control device. For the communication I/F unit 18, for example, communication standards, such as Wi-Fi (registered trademark), Bluetooth (registered trademark), and local area network (LAN), are used.

### Storage Unit

The storage unit 13 is realized by a hard disk drive (HDD), a solid state drive (SSD), a flash memory, or the like. An information processing program 13A is stored in the storage unit 13 as a storage medium. The recording medium 17 in which the information processing program 13A is written is set in the medium reading/writing device 16, and the medium reading/writing device 16 reads out the information processing program 13A from the recording medium 17, whereby the information processing program 13A is stored in the storage unit 13. The CPU 11 reads out the information processing program 13A from the storage unit 13 and loads the information processing program 13A into the memory 12, and sequentially executes processes included in the information processing program 13A. A color information database 13B, which will be described below, is stored in the storage unit 13.

### Functional Configuration of Control Device

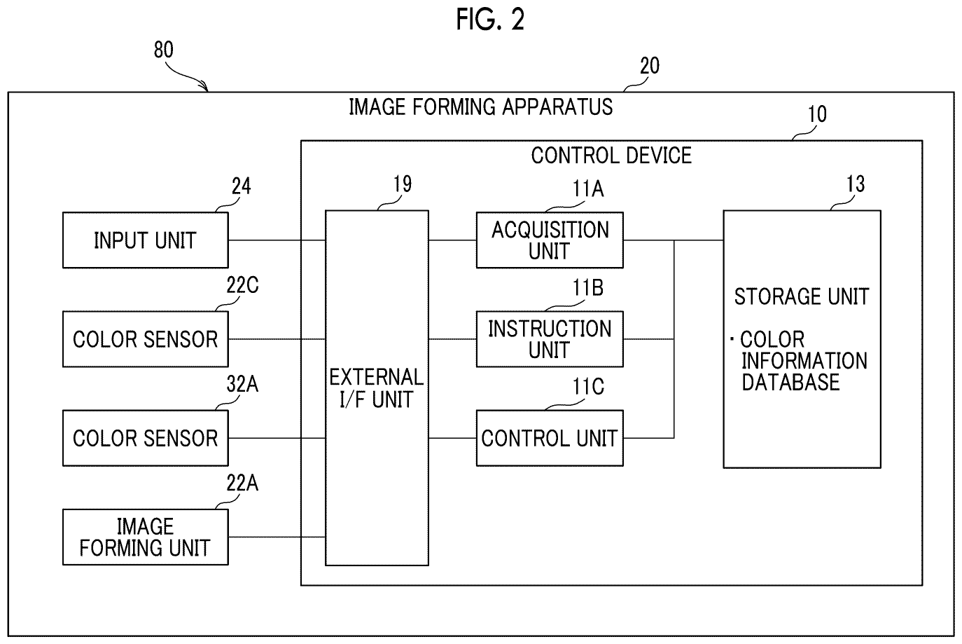

Next, a functional configuration of the control device 10 according to the present exemplary embodiment will be described with reference to FIG. 2. As shown in FIG. 2, the control device 10 includes an acquisition unit 11A, an instruction unit 11B, and a control unit 11C. The CPU 11 of the control device 10 executes the information processing program 13A to function as the acquisition unit 11A, the instruction unit 11B, and the control unit 11C.

### Acquisition Unit

The acquisition unit 11A acquires an execution instruction for the printing job via the input unit 24 from the user or an execution instruction for the printing job via the network. In this case, the acquisition unit 11A acquires “image information” which is document data for which the user has issued a printing instruction.

In addition, in a case in which a printing instruction for the hidden information is executed by the user, the acquisition unit 11A can acquire the “printing instruction for the hidden information” in addition to the execution instruction for the printing job.

The acquisition unit 11A acquires the color information of the coloring material filled in the cartridge 22B from the color sensor 22C. In addition, the acquisition unit 11A can also acquire the color information of the recording medium on which the image information for which the printing instruction has been issued is printed from the color sensor 32A.

### Instruction Unit

### Case of Not Acquiring Color of Recording Medium

A case in which the acquisition unit 11A does not acquire the color of the recording medium will be described. In this case, the instruction unit 11B instructs the image forming unit 22A to print the hidden information by using the predetermined first coloring material in a case of executing the printing of the image information on the recording medium using the plurality of coloring materials via the image forming unit 22A.

Specifically, in a case in which any of the cartridges 22B is filled with any of the yellow coloring material or the transparent coloring material, which is an example of the first coloring material, the instruction unit 11B instructs the image forming unit 22A “to print” the hidden information.

On the other hand, in a case in which none of the cartridges 22B is filled with the yellow coloring material or the transparent coloring material, which is an example of the first coloring material, the instruction unit 11B instructs the image forming unit 22A “not to print” the hidden information.

However, even in a case in which the hidden information is not printed, the instruction unit 11B instructs the image forming unit 22A to print the image information for which the printing instruction has been issued.

In addition, in a case in which the cartridge 22B filled with the first coloring material is replaced with the cartridge 22B filled with the second coloring material during the execution of the printing, the instruction unit 11B instruct the image forming unit 22A not to print the hidden information during the execution of the printing from this case onward.

That is, in a case in which the first coloring material is replaced with the second coloring material that does not print the hidden information during the printing of the image information and the hidden information using the first coloring material, the hidden information is not printed.

Similarly, in a case in which the cartridge 22B filled with the second coloring material is replaced with the cartridge 22B filled with the first coloring material during the execution of the printing, the instruction unit 11B instructs the image forming unit 22A to print the hidden information during the execution of the printing from this case onward.

That is, in a case in which the second coloring material is replaced with the first coloring material capable of printing the hidden information during the printing of the image information using the second coloring material (in this case, the hidden information is not printed), the hidden information is printed.

### Case of Acquiring Color of Recording Medium

A case in which the acquisition unit acquires the color of the recording medium will be described. In this case, the instruction unit 11B can print the hidden information using the second coloring material in a case in which the color of the recording medium and the color of the second coloring material match a predetermined combination during the execution of the printing of the image information on the recording medium via the image forming unit 22A using the plurality of coloring materials.

As an example, in a case in which a black coloring material, which is an example of the second coloring material, is filled in any of the cartridges 22B, and the color of the recording medium is black, the instruction unit 11B can instruct the image forming unit 22A to print the hidden information using the black coloring material.

As another example, in a case in which a white coloring material, which is an example of the second coloring material, is filled in any of the cartridges 22B, and the color of the recording medium is white, the instruction unit 11B can instruct the image forming unit 22A to print the hidden information using the white coloring material.

As described above, a combination of the color of the recording medium and the color of the second coloring material, which can print the hidden information, is stored in the color information database 13B. In addition to the above, examples of such a combination include blue: cyan, red: magenta, and pink: magenta as the color of the recording medium: the color of the second coloring material.

In addition, white as a color of the recording medium that can print the hidden information using the white coloring material can be defined as, for example, a color having a lightness L* of 80 or more in a color space.

Similarly, blue as a color of the recording medium that can print the hidden information using the cyan coloring material can be defined by the lightness L*, the chromaticity a* and b* in the color space. The same applies to other coloring materials and the color of the recording medium. As described above, a combination of the color of the recording medium and the color of the second coloring material that can print the hidden information can be optionally set by an administrator of the information processing system 80.

In the following description, the combination of the color of the recording medium and the color of the second coloring material, which can print the hidden information, will be referred to as “approximate color”. That is, in a case in which there is the approximate color between the color of the recording medium and the color of the second coloring material, the instruction unit 11B can print the hidden information by using the second coloring material having a color approximate to the color of the recording medium.

### Control Unit

The control unit 11C controls various functions provided in the image forming apparatus 20, such as the image forming unit 22A, the color sensor 22C, the display unit 24A, the duplexing auto document feeder 28, the image reading unit 30, the paper transport device 32, the color sensor 32A, and the like in the image forming apparatus 20. Various instructions by the instruction unit 11B may be executed via the control unit 11C.

### Hidden Information Printing Determination Processing 1

First, an aspect in which the CPU 11 of the control device 10 does not acquire the color information of the recording medium will be described. It should be noted that, in order to avoid complication, a case in which the printing instruction for the hidden information is executed by the user will be described. In a case in which the printing instruction for the hidden information is not executed by the user and the printing of the hidden information is determined in advance, step S102, which will be described below, is omitted.

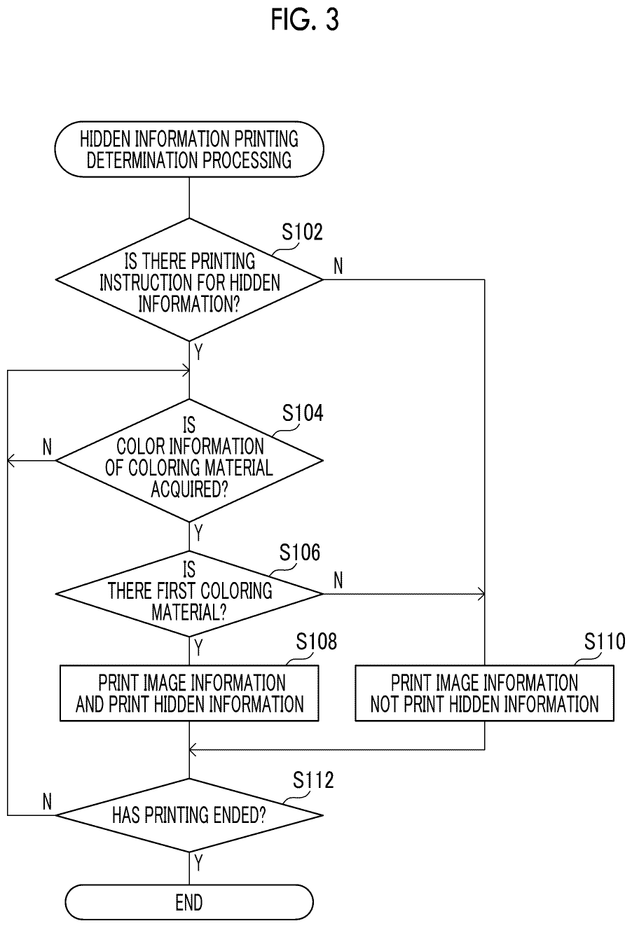

The CPU 11 executes “hidden information printing determination processing” shown in FIG. 3 in response to an execution instruction for the image information of the printing job via the input unit 42 of a user's device 40.

In a case in which the hidden information printing determination processing is executed, in step S102, the CPU 11 determines whether or not the printing instruction for the hidden information is acquired, along with the printing instruction for the image information. In a case in which an affirmative determination is made in step S102, the processing proceeds to step S104. On the other hand, in a case in which a negative determination is made in step S102, the processing proceeds to step S110.

In step S104, the CPU 11 executes a wait for acquisition of the color information of the coloring material filled in each cartridge 22B. In a case in which the color information of the coloring material filled in each cartridge 22B is acquired, the processing proceeds to step S106.

In step S106, the CPU 11 determines whether or not the first coloring material is included in any of the cartridges 22B from the acquired color information. In a case in which an affirmative determination is made in step S106, the processing proceeds to step S108. On the other hand, in a case in which a negative determination is made in step S106, the processing proceeds to step S110.

In step S108, the CPU 11 causes the image forming unit 22A to print the image information and to print the hidden information by using the first coloring material. After step S108, the processing proceeds to step $112.

In step S110, the CPU 11 causes the image forming unit 22A to print the image information and not to print the hidden information. After step S110, the processing proceeds to step S112.

In step S112, the CPU 11 determines whether or not the printing job for which the instruction has been issued has ended. In a case in which an affirmative determination is made in step S112, the hidden information printing determination processing ends.

On the other hand, in a case in which a negative determination is made in step S112, the processing returns to step S104. That is, until the printing job ends, the CPU 11 acquires the color information of the coloring material, and switches between the printing and the non-printing of the hidden information as necessary.

As a result, in a case in which the first coloring material is replaced with the second coloring material during the execution of the printing job, the CPU 11 causes the image forming unit 22A not to print the hidden information. In a case in which the second coloring material is replaced with the first coloring material during the execution of the printing job, the CPU 11 causes the image forming unit 22A to print the hidden information.

### Hidden Information Printing Determination Processing 2

Next, an aspect in which the CPU 11 of the control device 10 acquires the color information of the recording medium will be described. It should be noted that, in order to avoid complication, a case in which the printing instruction for the hidden information is executed by the user will be described. In a case in which the printing instruction for the hidden information is not executed by the user and the printing of the hidden information is determined in advance, step S202, which will be described below, is omitted.

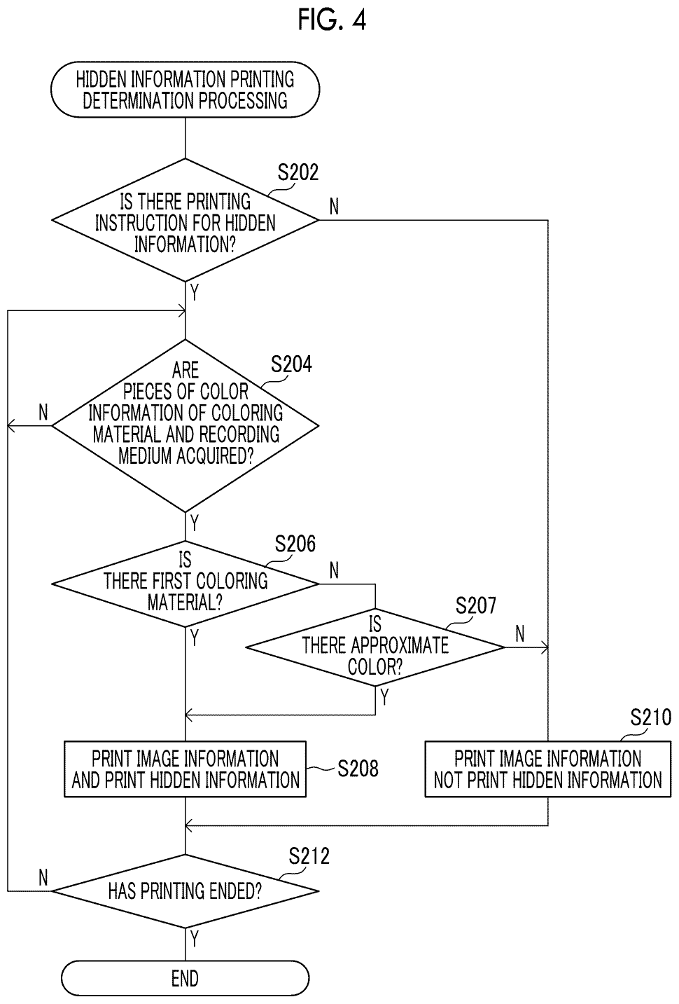

The CPU 11 executes “hidden information printing determination processing” shown in FIG. 4 in response to the execution instruction for the image information of the printing job via the input unit 42 of the user's device 40.

In a case in which the hidden information printing determination processing is executed, in step S202, the CPU 11 determines whether or not the printing instruction for the hidden information is acquired, along with the printing instruction for the image information. In a case in which an affirmative determination is made in step S202, the processing proceeds to step S204. On the other hand, in a case in which a negative determination is made in step S202, the processing proceeds to step S210.

In step S204, the CPU 11 executes a wait for acquisition of the color information of the coloring material filled in each cartridge 22B and the color information of the recording medium. In a case in which the color information of the coloring material filled in each cartridge 22B and the color information of the recording medium are acquired, the processing proceeds to step S206.

In step S206, the CPU 11 determines whether or not the first coloring material is included in any of the cartridges 22B from the acquired color information. In a case in which an affirmative determination is made in step S206, the processing proceeds to step S208. On the other hand, in a case in which a negative determination is made in step S206, the processing proceeds to step S207.

In step S207, the CPU 11 determines whether or not there is the approximate color between the color of the recording medium and the color of the second coloring material. In a case in which there is the approximate color, the processing proceeds to step S208. On the other hand, in a case in which a negative determination is made in step S207, the processing proceeds to step S210.

In step S208, the CPU 11 causes the image forming unit 22A to print the image information and to print the hidden information. In this case, in a case in which an affirmative determination is made in step S206, the hidden information is printed by using the first coloring material. On the other hand, in a case in which an affirmative determination is made in step S207, the hidden information is printed by using the second coloring material having the approximate color to the recording medium. After step S208, the processing proceeds to step S212.

In step S210, the CPU 11 causes the image forming unit 22A to print the image information and not to print the hidden information. After step S210, the processing proceeds to step S212.

In step S212, the CPU 11 determines whether or not the printing job for which the instruction has been issued has ended. In a case in which an affirmative determination is made in step S212, the hidden information printing determination processing ends.

On the other hand, in a case in which a negative determination is made in step S212, the processing returns to step S204. That is, until the printing job ends, the CPU 11 acquires the color information of the coloring material and the color information of the recording medium, and switches between the printing and the non-printing of the hidden information as necessary.

As a result, the CPU 11 causes the image forming unit 22A not to print the hidden information in a case in which the first coloring material is replaced with the second coloring material during the execution of the printing job and there is no approximate color between the color of the recording medium and the color of the second coloring material.

In addition, in a case in which the second coloring material is replaced with the first coloring material during the execution of the printing job, and in a case in which the second coloring material not having the approximate color to the recording medium is replaced with the second coloring material having the approximate color to the recording medium, the CPU 11 causes the image forming unit 22A to print the hidden information.

### Actions and Effects

In the information processing system 80 according to the exemplary embodiment of the present disclosure, in a case in which the first coloring material determined in advance in advance as the coloring material for printing the hidden information is replaced with the second coloring material, the hidden information is not printed. As a result, the hidden information may be prevented from being printed by using the second coloring material. That is, the hidden information may be prevented from being printed by using a color such as black, which is more conspicuous than yellow or a transparent color.

In addition, in the information processing system 80 according to the exemplary embodiment of the present disclosure, in a case in which the first coloring material is replaced with the second coloring material, the image information is printed, and the hidden information is not printed. As a result, the image information may be printed while preventing the hidden information from being printed by using the second coloring material.

In addition, in the information processing system 80 according to the exemplary embodiment of the present disclosure, in a case in which the second coloring material is replaced with the first coloring material, the image information is printed, and the hidden information is printed. As a result, the hidden information is printed in a case of printing the image information by using the first coloring material. In other words, the hidden information may be prevented from not being printed.

For example, during the execution of the printing job in which the hidden information is not printed (as an example, a printing job using a coloring material of black, cyan, magenta, or gold not including the first coloring material), the user can replace the second coloring material (for example, the gold coloring material) with the first coloring material (for example, the yellow coloring material). In this case, the printing job is executed by using the first coloring material instead of the second coloring material before the replacement.

In a case in which a state in which the hidden information is not printed is maintained in such a state, the hidden information is not printed by using the first coloring material, even though the printing of the image information is executed by using the coloring material including the first coloring material. On the other hand, in the present disclosure, in a case in which the second coloring material is replaced with the first coloring material, the hidden information is printed. As a result, in a case in which the printing of the image information is executed by using the coloring material including the first coloring material, the hidden information is also printed.

In addition, in the information processing system 80 according to the exemplary embodiment of the present disclosure, the color information indicating whether the coloring material filled in the cartridge 22B is the first coloring material or the second coloring material is acquired from the color sensor 22C capable of identifying the color of the coloring material. As a result, prevent the actual color of the coloring material may be prevented from being acquired by mistake as compared with, for example, a case of acquiring the color information applied to the cartridge 22B filled with the coloring material.

In addition, in the information processing system 80 according to the exemplary embodiment of the present disclosure, the first coloring material is a yellow or transparent coloring material. For example, the yellow coloring material is less conspicuous in a case of being printed on a recording medium having a high lightness of color. The transparent coloring material is less conspicuous in a case of being printed, regardless of the color of the recording medium. By using such a color as the first coloring material, the hidden information may be prevented from being printed in a color that is more conspicuous than yellow or a transparent color.

In addition, in the information processing system 80 according to the exemplary embodiment of the present disclosure, the hidden information may be printed by using the second coloring material in a case in which the color of the recording medium and the color of the second coloring material match the predetermined combination. As a result, the hidden information may be printed by using the coloring material other than the first coloring material, depending on the color of the recording medium. For example, the hidden information may be printed by using a white second coloring material on a white recording medium. Therefore, the hidden information is less conspicuous.

### Other Exemplary Embodiments

In the above-described exemplary embodiment, in a case in which the first coloring material is replaced with the second coloring material, the image information is printed and the hidden information is not printed, but the exemplary embodiment of the present disclosure is not limited to this. For example, in a case in which the first coloring material is replaced with the second coloring material, the image information need not be printed. That is, the image information need not be printed by using the second coloring material that cannot print the hidden information.

In addition, in the above-described exemplary embodiment, the color information indicating whether the coloring material is the first coloring material or the second coloring material is acquired from the color sensor 22C capable of identifying the color of the coloring material, but the exemplary embodiment of the present disclosure is not limited to this. For example, the color information may be acquired from a two-dimensional code or the like applied to the cartridge filled with the coloring material.

In addition, in the above-described exemplary embodiment, the first coloring material is a yellow or transparent coloring material, but the exemplary embodiment of the present disclosure is not limited thereto. The color of the first coloring material can be appropriately set depending on the color of the recording medium to be used.

In addition, in the above-described exemplary embodiment, both the exemplary embodiment in which the color of the recording medium is acquired and the exemplary embodiment in which the color of the recording medium is not acquired are described, but whether or not the color of the recording medium is acquired can be appropriately set even in a case in which the color sensor 32A is provided. In addition, even in a case of acquiring the color of the recording medium, whether or not to print the hidden information can be appropriately set depending on the combination of the color of the recording medium and the color of the second coloring material.

In the above-described exemplary embodiment, for example, as the hardware structure of the processing unit that executes the processing of each of the acquisition unit 11A, the instruction unit 11B, and the control unit 11C, various processors shown below can be used.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

As an example of configuring the processing unit with one processor, first, there is a form in which one processor is configured by a combination of one or more CPUs and software and the processor functions as the processing unit, as represented by computers such as a client and a server. Second, there is a form in which a processor that realizes the functions of the entire system including the processing unit with one integrated circuit (IC) chip is used, as represented by a system-on-chip (SoC) or the like. As described above, the processing unit is configured by using one or more of the various processors as the hardware structure.

Further, as the hardware structure of these various processors, more specifically, an electric circuit (circuitry) in which circuit elements, such as semiconductor elements, are combined can be used. As described above, the present disclosure can be implemented in various aspects.

### Supplementary Note

(((1)))

An information processing system comprising:
at least one processor configured to:
   print hidden information by using a predetermined first coloring material in a case of executing printing of image information on a recording medium using a plurality of coloring materials; and
   not print the hidden information in a case in which the first coloring material is replaced with a second coloring material.
(((2)))

The information processing system according to (((1))), wherein the processor is configured to:
print the image information and not print the hidden information in a case in which the first coloring material is replaced with the second coloring material.
(((3))) The information processing system according to (((1))) or (((2))), wherein the processor is configured to:
print the image information and print the hidden information in a case in which the second coloring material is replaced with the first coloring material.
(((4)))

The information processing system according to any one of (((1))) to (((3))), wherein the processor is configured to:
acquire color information indicating whether the coloring material is the first coloring material or the second coloring material from a color identification sensor capable of identifying a color of the coloring material.
(((5))

The information processing system according to any one of (((1)) to (4)
wherein the first coloring material is a yellow or transparent coloring material, and
the second coloring material is a coloring material of a color other than yellow and a transparent color.
(((6))

The information processing system according to any one of (((1))) to (((5))), wherein the processor is configured to:
acquire a color of the recording medium; and
print the hidden information by using the second coloring material in a case in which the color of the recording medium and a color of the second coloring material match a predetermined combination.
(((7)))

The information processing system according to (((6))), wherein the processor is configured to:
print the hidden information in a case in which the color of the second coloring material is white and the color of the recording medium is white.
(((8)))

An information processing program causing a computer to execute a process comprising:
printing hidden information by using a predetermined first coloring material in a case of executing printing of image information on a recording medium using a plurality of coloring materials; and
not printing the hidden information in a case in which the first coloring material is replaced with a second coloring material.
(((9)))

An information processing method comprising:
printing hidden information by using a predetermined first coloring material in a case of executing printing of image information on a recording medium using a plurality of coloring materials; and
not printing the hidden information in a case in which the first coloring material is replaced with a second coloring material.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
at least one processor configured to:
print hidden information by using a predetermined first coloring material in a case of executing printing of image information on a recording medium using a plurality of coloring materials; and
not print the hidden information in a case in which the first coloring material is replaced with a second coloring material.

2. The information processing system according to claim 1, wherein the processor is configured to:
print the image information and not print the hidden information in a case in which the first coloring material is replaced with the second coloring material.

3. The information processing system according to claim 2, wherein the processor is configured to:
print the image information and print the hidden information in a case in which the second coloring material is replaced with the first coloring material.

4. The information processing system according to claim 1, wherein the processor is configured to:
acquire color information indicating whether the coloring material is the first coloring material or the second coloring material from a color identification sensor capable of identifying a color of the coloring material.

5. The information processing system according to claim 1,
wherein the first coloring material is a yellow or transparent coloring material, and
the second coloring material is a coloring material of a color other than yellow and a transparent color.

6. The information processing system according to claim 1, wherein the processor is configured to:
acquire a color of the recording medium; and
print the hidden information by using the second coloring material in a case in which the color of the recording medium and a color of the second coloring material match a predetermined combination.

7. The information processing system according to claim 6, wherein the processor is configured to:
print the hidden information in a case in which the color of the second coloring material is white and the color of the recording medium is white.

8. A non-transitory computer readable medium storing an information processing program causing a computer to execute a process comprising:
printing hidden information by using a predetermined first coloring material in a case of executing printing of image information on a recording medium using a plurality of coloring materials; and
not printing the hidden information in a case in which the first coloring material is replaced with a second coloring material.

9. An information processing method comprising:
printing hidden information by using a predetermined first coloring material in a case of executing printing of image information on a recording medium using a plurality of coloring materials; and
not printing the hidden information in a case in which the first coloring material is replaced with a second coloring material.
